(19) United States
(12) Patent Application Publication
(10) Pub. No.: US 2021/0219041 A1
(43) Pub. Date: Jul. 15, 2021

(54) VOICE DATA TRANSMISSION METHOD, WIRELESS EARPHONE AND TWS EARPHONE

(71) Applicant: GOERTEK TECHNOLOGY CO., LTD., Qingdao (CN)

(72) Inventors: Tao ZHANG, Qingdao (CN); Ying ZHAO, Qingdao (CN)

(21) Appl. No.: 17/055,008

(22) PCT Filed: Jul. 26, 2018
(86) PCT No.: PCT/CN2018/097209

§ 371 Date: Nov. 12, 2020

(30) Foreign Application Priority Data
Jun. 6, 2018 (CN) 201810573674.9

(51) Int. Cl. H04R 1/10; H04W 76/14; H04L 29/08; H04R 1/08; H04R 5/033

(52) U.S. Cl. CPC H04R 1/1041; H04W 76/14; H04L 69/324; H04R 2420/07; H04R 5/033; H04R 2201/10; H04R 1/08

(57) ABSTRACT

Provided are a method for transmitting voice data, a wireless headset and a TWS headset. In the method, a first wireless headset establishes a communication connection with a terminal through first connection parameter information, and a second wireless headset receives an instruction to continue transmitting voice data, wherein the instruction to continue transmitting voice data is an instruction generated after detecting a preset event indicating that the first wireless headset is about to interrupt transmission of voice data; and transmitting, by the second wireless headset, the voice data collected by the MIC of the second wireless headset to the terminal through the first connection parameter information sent by the first wireless headset.

This application claims the priority to Chinese Patent Application No. 201810573674.9, titled “VOICE DATA TRANSMISSION METHOD, WIRELESS EARPHONE AND TWS EARPHONE”, filed on Jun. 6, 2018 with the China National Intellectual Property Administration (CNIPA), which is incorporated herein by reference in its entirety.

### FIELD

The present disclosure relates to the technical field of portable listening devices, in particular to a method for transmitting voice data, a wireless headset, a true wireless stereo (TWS) headset and a computer-readable storage medium.

### BACKGROUND

A true wireless stereo (TWS) headset is composed of a first wireless headset and a second wireless headset. At present, there are mainly the following two technical solutions for the TWS headset transmitting voice data to a corresponding terminal.

In the first technical solution, only one wireless headset in the TWS headset has a microphone (MIC), and when voice data needs to be transmitted to the corresponding terminal, the wireless headset with the MIC transmits the voice data.

In the second technical solution, the first wireless headset and the second wireless headset each has a MIC. When voice data needs to be transmitted to the corresponding terminal, firstly the first wireless headset or the second wireless headset is selected as a master wireless headset, and then voice data is transmitted by the master wireless headset.

For the above two solutions in transmitting voice data, if the wireless headset that transmits voice data cannot continue to transmit voice data, for example, the wireless headset that transmits voice data is taken off, the first solution may result in an interruption of voice data transmission, or a direct switch to the terminal to collect voice data which means the wireless headset with the MIC is not used to transmit voice data; the second solution may result in an interruption of voice data or result that the other wireless headset has to be switched as the master wireless headset, and then the switched master wireless headset is used to transmit voice data, which means in this way, the master-slave switch is required, and the two wireless headsets may be disconnected from the terminal during the process of the master-slave switch. In general, both the first solution and the second solution will cause the interruption of voice data transmission, thus affecting user experience.

### SUMMARY

The objectives of the present disclosure are to provide a method for transmitting voice data, a wireless headset, a TWS headset, and a computer-readable storage medium, to realize uninterrupted voice data transmission and improve user experience.

In order to solve the above technical problems, a method for transmitting voice data is provided in the present disclosure, in which a first wireless headset establishes a communication connection with a terminal through first connection parameter information, and a second wireless headset does not establish a communication connection with the terminal. The method includes:

collecting, by a MIC of the second wireless headset, voice data when the second wireless headset receives an instruction to continue transmitting voice data, wherein the instruction to continue transmitting voice data is an instruction generated after detecting a preset event indicating that the first wireless headset is about to interrupt transmission of the voice data, and

transmitting, by the second wireless headset, the voice data collected by the MIC of the second wireless headset to the terminal through the first connection parameter information sent by the first wireless headset.

In an embodiment, before the second wireless headset receives an instruction to continue transmitting voice data, the method further includes:

receiving the first connection parameter information sent by the first wireless headset.

In an embodiment, the collecting, by a MIC of the second wireless headset, voice data when the second wireless headset receives an instruction to continue transmitting voice data includes:

turning on the MIC of the second wireless headset and collecting voice data by the MIC of the second wireless headset, when the second wireless headset receives the instruction to continue transmitting voice data.

In an embodiment, the preset event refers that the first wireless headset is taken off.

In an embodiment, the transmitting, by the second wireless headset, the voice data collected by the MIC of the second wireless headset to the terminal through the first connection parameter information sent by the first wireless headset includes:

packaging, by the second wireless headset, the voice data collected by the MIC of the second wireless headset through the first connection parameter information, and transmitting the packaged voice data to the terminal, wherein the first connection parameter information includes MAC address of the terminal, communication time slot, and header information.

A wireless headset is further provided in the present disclosure. The wireless headset includes a communication interface, a MIC, a memory and a processor, where the memory is configured to store a computer program, and the processor, when executing the computer program, is configured to implement steps of the method for transmitting voice data described above.

A true wireless stereo (TWS) headset is further provided in the present disclosure. The TWS headset includes a first wireless headset and a second wireless headset each having a MIC, where the first wireless headset establishes a communication connection with a terminal through first connection parameter information, and the second wireless headset does not establish a communication connection with the terminal,

the second wireless headset collects voice data by means of the MIC of the second wireless headset, when the second wireless headset receives an instruction to continue transmitting voice data; and

the second wireless headset transmits the voice data collected by the MIC of the second wireless headset to the terminal through the first connection parameter information sent by the first wireless headset;

the instruction to continue transmitting voice data is an instruction generated after detecting a preset event indicating that the first wireless headset is about to interrupt transmission of the voice data.

In an embodiment, wherein the first wireless headset sends the first connection parameter information to the second wireless headset after the first wireless headset establishes the communication connection with the terminal through the first connection parameter information.

In an embodiment, the first wireless headset sends the instruction to continue transmitting voice data to the second wireless headset in response to detecting the preset event.

In an embodiment, the second wireless headset turns on the MIC of the second wireless headset and collects voice data through the MIC of the second wireless headset, upon receiving the instruction to continue transmitting voice data.

A computer-readable storage medium is further provided in the present disclosure, where the computer-readable storage medium stores a computer program, and the computer program, when executed by a processor, implements steps of the method for transmitting voice data described above.

In the method for transmitting voice data according to the present disclosure, the first wireless headset establishes a communication connection with a terminal through the first connection parameter information, and the second wireless headset does not establish a communication connection with the terminal. The method includes: collecting, by a MIC of the second wireless headset, voice data when the second wireless headset receives an instruction to continue transmitting voice data, where the instruction to continue transmitting voice data is an instruction generated after detecting a preset event indicating that the first wireless headset is about to interrupt transmission of the voice data; and transmitting, by the second wireless headset, the voice data collected by the MIC of the second wireless headset to the terminal through the first connection parameter information sent by the first wireless headset.

It can be seen that, in the method, the first connection parameter information is transmitted to the second wireless headset when the first wireless headset is about to interrupt transmission of the voice data to the terminal, so that the second wireless headset can continue transmitting voice data to the terminal according to the first connection parameter information; that is, the second wireless headset directly implements data interaction with the terminal according to the existing first connection parameter information, so as to realize the uninterrupted transmission of voice data and improve user experience. The method avoids, the tedious process in the conventional technology when the voice data transmission needs to be interrupted, since it is required to perform a master-slave switching first, establish a connection with the terminal by the switched master wireless headset, and continue transmitting voice data through this connection; and thus avoids disconnection between the wireless headset and the terminal caused by the master-slave switching. The wireless headset, the TWS headset, and the computer-readable storage medium according to the present disclosure have the above-mentioned beneficial effects, which will not be repeated here.

### BRIEF DESCRIPTION OF THE DRAWINGS

The drawings to be used in the description of the embodiments or the conventional technology will be described briefly as follows, so that the technical solutions according to the embodiments of the present disclosure or according to the conventional technology will become clearer. It is apparent that the drawings in the following description only illustrate some embodiments of the present disclosure. For those skilled in the art, other drawings may be obtained according to these drawings without any creative work.

FIG. 1 shows a flow chart of a method for transmitting voice data according to an embodiment of the present disclosure;

FIG. 2 shows a structural block diagram of a TWS headset according to an embodiment of the present disclosure;

FIG. 3 shows a connection schematic diagram when two headsets in the TWS headset each is in an operation state, according to an embodiment of the present disclosure; and

FIG. 4 shows a connection schematic diagram when a slave headset in the TWS headset is in an operation state and a master headset in the TWS headset is taken off, according to an embodiment of the present disclosure.

### DETAILED DESCRIPTION OF EMBODIMENTS

The technical solutions in the embodiments of the present disclosure will be described clearly and completely in conjunction with the accompanying drawings in the embodiments of the present disclosure, in order to make the objects, technical solutions, and advantages of the embodiments of the present disclosure clearer. Obviously, the described embodiments are a part of the embodiments of the present disclosure, rather than all of the embodiments. Based on the embodiments of the present disclosure, all other embodiments obtained by those ordinary skilled in the art without creative work shall fall within the protection scope of the present disclosure.

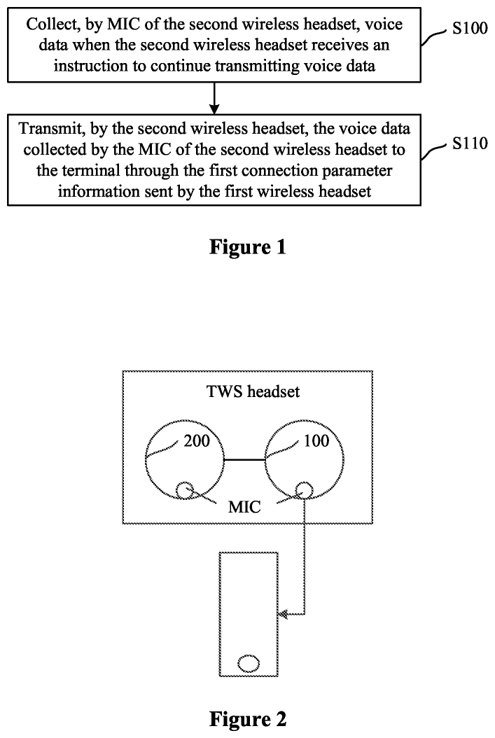

In the conventional technology, when a master wireless headset needs to interrupt transmission of voice data to a terminal, for example, when a first wireless headset is taken off during a call, it is required to perform a master-slave switching first, then establish a connection with the terminal by the switched master wireless headset, and continue transmitting voice data through the connection. Due to the master-slave switching during this process, there is necessary to have a time period in which the terminal disconnects from the master wireless headset, thus interrupting the transmission of voice data and affecting user experience. In the embodiment, when a first wireless headset cannot continue transmitting voice data, a second wireless headset transmits voice data to the terminal through current connection information about the first wireless headset and the terminal, which avoids the master-slave switching process, realizes uninterrupted transmission of voice data, and improves user experience. Reference is made to FIG. 1 for details, which is a flowchart of a method for transmitting voice data according to an embodiment of the present disclosure. The method may include the following steps S100 and S110.

In step S100, voice data is collected by a MIC of a second wireless headset, when a second wireless headset receives an instruction to continue transmitting voice data, where the instruction to continue transmitting voice data is an instruction generated after detecting a preset event indicating that a first wireless headset is about to interrupt transmission of the voice data.

The first wireless headset in the embodiment refers to a wireless headset that is wirelessly connected to the terminal currently, or may also be understood as a wireless headset that is wirelessly connected to the terminal before a preset event occurs and uploads voice data to the terminal. The second wireless headset refers to a wireless headset that is not wirelessly connected to the terminal currently. Specifically, the first wireless headset establishes a communication connection with the terminal through first connection parameter information, and the second wireless headset does not establish a communication connection with the terminal.

Specifically, the step S100 mainly aims to collect voice data, that needs to be continuously transmitted, by the MIC of the second wireless headset when the first wireless headset is about to interrupt transmission of the voice data, so that the second wireless headset subsequently transmit the voice data collected by the MIC of the second wireless headset to the terminal through the first connection parameter information, in order to achieve continuous and uninterrupted transmission of the collected voice data.

The preset event is not specifically limited in the embodiment, and may be set by a user according to an actual situation. For example, the preset event may be that the first wireless headset is taken off, or may be that power of the first wireless headset is too low. The number of preset event(s) is not limited in the embodiment, either. For example, only one preset event is set, such as the first wireless headset is taken off. Alternatively, two preset events may also be set, such as the first preset event is that the first wireless headset is taken off and the second preset event is that the power of the first wireless headset is lower than a first threshold. At this time, an instruction to continue transmitting voice data is generated in response to detecting any one of the two preset events. Further, a method for detecting the preset event is not limited in the embodiment, and a corresponding detection method may be determined by the user according to the specific content of the preset event. For example, in a case that the preset event is that the first wireless headset is taken off, it may be determined that the preset event occurs by detecting changes in a state of the first wireless headset from a worn state to an unworn state. A main body for detecting the preset event is not limited in the embodiment. For example, the main body for detecting the preset event may be the first wireless headset or the second wireless headset. Specifically, the second wireless headset may detect a communication process between the first wireless headset and the terminal through the first connection parameter information, when the second wireless headphone acquires the first connection parameter information, thus to determine whether the preset event occurs by determining whether the communication process is normal. Generally, for the accuracy and reliability in detection of the preset event, the first wireless headset is used to detect whether the preset event occurs thereto, the instruction to continue transmitting voice data is generated when it is detected that the preset event occurs to the first wireless headset, and the instruction to continue transmitting voice data is sent to the second wireless headset.

The specific form of the instruction to continue transmitting voice data is not limited in the embodiment. For example, the instruction to continue transmitting voice data may be a specific high or low level, or a small piece of data codes, or an identifier, or the like. The user may determine a required form of the instruction according to an actual situation.

In the embodiment, the second wireless headset collects voice data through the MIC of the second wireless headset, in response to receiving the instruction to continue transmitting voice data. That is, the MIC on the second wireless headset is used to collect voice data. The timing when the MIC of the second wireless headset is turned on is not limited in the embodiment. For example, the MIC of the second wireless headset is always in an on state when the second wireless headset is in an operation state; or the MIC of the second wireless headset is turned on immediately when the second wireless headset receives the instruction to continue transmitting voice data. That is, as long as it is ensured that the MIC of the second wireless headset is in the on state when the MIC of the second wireless headset needs to be used to collect voice data when the second wireless headset receives the instruction to continue transmitting voice data.

Further, in order to reduce power consumption of the second wireless headset, the MIC of the second wireless headset is in an off state when the second wireless headset is not needed to collect voice data. Preferably, it is to turn on the MIC of the second wireless headset when the second wireless headset receives the instruction to continue transmitting voice data, and to use the MIC of the second wireless headset to collect voice data.

In step S110, the voice data collected by the MIC of the second wireless headset is transmitted by the second wireless headset to the terminal through the first connection parameter information sent by the first wireless headset.

The first connection parameter information refers to current connection information between the first wireless headset and the terminal. The content of the first connection parameter information is not limited in the embodiment, as long as a connection between the first wireless headset and the terminal can be established through the first connection parameter information, thus to realize data interaction. Optionally, in a case that the first connection parameter information includes a MAC address of the terminal, communication time slot and header information, the transmitting, by the second wireless headset, the voice data collected by the MIC of the second wireless headset to the terminal through the first connection parameter information sent by the first wireless headset may include: packaging, by the second wireless headset, the voice data collected by the MIC of the second wireless headset through the first connection parameter information, and transmitting the packaged voice data to the terminal.

The second wireless headset may establish a pseudo-connection with the terminal by means of the first connection parameter information, that is, the second wireless headset sends the voice data collected by the MIC of the second wireless headset to the terminal through a connection channel between the first wireless headset and the terminal, without actually establishing a new connection channel between the second wireless headset and the terminal. Based on this, in the embodiment, it is not required to perform a master-slave switching between the first wireless headset and the second wireless headset firstly, disconnect the connection channel between the first wireless headset and the terminal, re-establish the connection channel between the second wireless headset and the terminal, and finally send the voice data by the second wireless. In this switching process, the wireless headset is disconnected from the terminal, thereby resulting in an interruption of voice data transmission. Instead, the second wireless headset directly uses the connection channel between the first wireless headset and the terminal to continue transmitting voice data to the terminal, thereby realizing uninterrupted transmission. From the perspective of user experience, there is no disconnection between the wireless headset and the terminal, and the user can continuously receive voice data through the connection channel corresponding to the first connection parameter information.

The timing when the first wireless headset sends the first connection parameter information to the second wireless headset is not limited in the embodiment. For example, the first connection parameter information may be sent by the first wireless headset to the second wireless headset immediately after the first wireless headset and the second wireless headset establish a connection. Alternatively, the first connection parameter information may be sent along with the instruction to continue transmitting the voice data from the first wireless headset to the second wireless headset. That is, the first connection parameter information can be acquired, as long as the second wireless headset needs to use the first connection parameter information to send the voice data collected by the MIC of the second wireless headset to the terminal. Further, in order to ensure that the voice data collected by the MIC of the second wireless headset can be transmitted to the terminal in time, the sooner the first wireless headset sends the first connection parameter information to the second wireless headset, the better it is. Preferably, the first connection parameter information sent by the first wireless headset is received by the second wireless headset before receiving the instruction to continue transmitting the voice data. That is, the second wireless headset has acquired the first connection parameter information before receiving the instruction to continue transmitting the voice data, such as when the first wireless headset and the second wireless headset successfully establish a connection. For example, during using the TWS headset, data may be transmitted after the first wireless headset establishes a connection with the terminal (e.g., a mobile phone), so as to realize data sharing between the first wireless headset and the terminal. At this time, the first wireless headset may send the first connection information on the first wireless headset and the terminal to the second wireless headset, under a premise that the first wireless headset has established a wireless connection with the second wireless headset. Thus, the second wireless headset may know the process of data transmission between the first wireless headset and the terminal in real time, and may also establish a pseudo-connection with the terminal through the first connection information, and send data to the terminal through the pseudo-connection, to realize data interaction with the terminal.

Further, in order to ensure that the second wireless headset successfully receives the first connection parameter information, a feedback mechanism may also be established in the embodiment. Thus it is ensured that the second wireless headset successfully receives the first connection parameter information by means of the feedback mechanism. The method for executing the feedback mechanism is not specifically limited in the embodiment. For example, it may be that the second wireless headset sends feedback information indicating successful reception to the first wireless headset upon successfully receiving the first connection parameter information, and the first wireless headset determines that the second wireless headset has successfully received the first connection parameter information upon receiving the feedback information. Alternatively, it may be that the second wireless headset sends a request to the first wireless headset for re-acquiring the first connection parameter information until the second wireless headset successfully receives the first connection parameter information, if the second wireless headset does not receive the first connection parameter information within a specified time period.

The above process is described as the following in conjunction with an application example of wireless headsets in a call scenario. If the first wireless headset and the second wireless headset are both worn by a user and the first wireless headset establishes a Bluetooth connection with a mobile phone, at this time, audio data (i.e., voice data) uploaded from the wireless headset to the mobile phone during a voice call is generated by the MIC of the first wireless headset. If the first wireless headset is taken off and only the second wireless headset is worn at this moment, the MIC of the first wireless headset is turned off and the MIC of the second wireless headset is turned on, and at this time, audio data uploaded during the voice call is generated by the MIC of the second wireless headset. There is no Bluetooth connection between the second wireless headset and the mobile phone, but the second wireless headset has acquired the first connection parameter information (such as, MAC address of the mobile phone, communication time slot, and header information) about the communication between the first wireless headset and the mobile phone. The second wireless headset may form a pseudo-connection with the mobile phone through the first connection parameter information, and the second wireless headset uploads the audio data to the mobile phone.

Based on the above technical solutions, the method for transmitting voice data according to the embodiments of the present disclosure has two advantages over the conventional technology. First, when the transmission of voice data needs to be interrupted, the second wireless headset continues sending the collected voice data to the terminal by directly using the first connection parameter information, without the master-slave switching between the first wireless headset and the second wireless headset. Instead, it may be simply switched the MIC in operation from the MIC of the first wireless headset to the MIC of the second wireless headset, thus avoiding disconnection between the wireless headset and the terminal due to the master-slave switching. Secondly, the second wireless headset may transmit voice data to the terminal by immediately using the first connection parameter information upon receiving the instruction to continue transmitting voice data, without interrupting the transmission of voice data. In the solution of the present disclosure, it is not required to perform operations in the conventional technology of re-establishing a connection between the second wireless headset and the terminal, obtain second connection parameter information, and transmit voice data through the second connection parameter information, thereby avoiding the problem of interruption of voice data transmission caused by the newly-established channel. In general, the solution in this embodiment can achieve uninterrupted transmission of voice data. For example, a call will not be disconnected when any one of wireless headsets is taken off during a call using a TWS headset.

A wireless headset, a TWS headset, and a computer-readable storage medium according to embodiments of the present disclosure will be introduced below. The wireless headset, the TWS headset, and the computer-readable storage medium described below may be referred to the method for transmitting voice data described above.

A wireless headset is also provided in an embodiment of the present disclosure. The wireless headset includes a communication interface, a MIC, a memory, and a processor. The memory is configured to store a computer program, and the processor, when executing the computer program, is configured to implement steps of the method for transmitting voice data according to the above embodiment. For example, the processor, when executing the computer program, is configured to implement steps of: collecting, by a MIC of the second wireless headset, voice data when the second wireless headset receives an instruction to continue transmitting voice data, where the instruction to continue transmitting voice data is an instruction generated after detecting a preset event indicating that the first wireless headset is about to interrupt transmission of the voice data; and transmitting, by the second wireless headset, the voice data collected by the MIC of the second wireless headset to the terminal through the first connection parameter information sent by the first wireless headset.

Reference is made to FIG. 2, which shows a structural block diagram of a TWS headset according to an embodiment of the present disclosure. TWS means true wireless stereo, and the TWS headset refers to a headset applying the TWS technology. Specifically, the TWS headset includes a first wireless headset 100 and a second wireless headset 200 each having a MIC. The first wireless headset 100 establishes a communication connection with a terminal through first connection parameter information, and the second wireless headset 200 does not establish a communication connection with the terminal.

The second wireless headset 200 collects voice data by means of the MIC of the second wireless headset, when the second wireless headset 200 receives an instruction to continue transmitting voice data; and the second wireless headset 200 transmits the voice data collected by the MIC of the second wireless headset to the terminal through the first connection parameter information sent by the first wireless headset 100; where the instruction to continue transmitting voice data is an instruction generated after detecting a preset event indicating that the first wireless headset 100 is about to interrupt transmission of the voice data.

The first wireless headset 100 needs to be connected to the terminal as well as to the second wireless headset 200, while the terminal only needs to be connected to the first wireless headset 100, and the second wireless headset 200 only needs to be connected to the first wireless headset 100.

Further, in order to ensure the accuracy of the first connection parameter information, it is necessary to check the established connection between the first wireless headset and the terminal upon sending the first connection parameter information, to ensure the reliability of the connection state. The timing and method for checking the connection state is not limited in the embodiment, and may be set by a user according to an actual situation. For example, the timing may be when it is detected that voice data needs to be transmitted, such as when a call event is received. The timing may also be when both wireless headsets are in the wearing state. For example, the detection process may be that when the first wireless headset is about to send the first connection parameter information to the second wireless headset, the first wireless headset checks its connection state (e.g., BT connection state) with the terminal, and then sends the first connection parameter information to the second wireless headset after confirming that the connection state is normal. Alternatively, the detection process may be that when the first wireless headset is about to send the first connection parameter information to the second wireless headset, the first wireless headset checks its connection state (e.g., BT connection state) respectively with the terminal and with the second wireless headset, and then sends the first connection parameter information to the second wireless headset after confirming that both connection states are normal. The method for checking the connection state is not specifically limited in this embodiment.

Preferably, based on the above embodiment, the first wireless headset 100 sends the first connection parameter information to the second wireless headset 200 after establishing a communication connection with the terminal through the first connection parameter information.

Specifically, the timing for turning off the MIC of the first wireless headset is not limited in the embodiment. For example, the MIC of the first wireless headset may be turned off when the instruction to continue transmitting voice data is sent to the second wireless headset 200. Alternatively, the MIC of the first wireless headset may be turned off after the MIC of the second wireless headset is turned on.

Based on any of the foregoing embodiments, the first wireless headset 100 sends the instruction to continue transmitting voice data to the second wireless headset 200 upon detecting a preset event.

Based on any of the foregoing embodiments, the second wireless headset 200 turns on the MIC of the second wireless headset and collects voice data through the MIC of the second wireless headset, upon receiving the instruction to continue transmitting voice data.

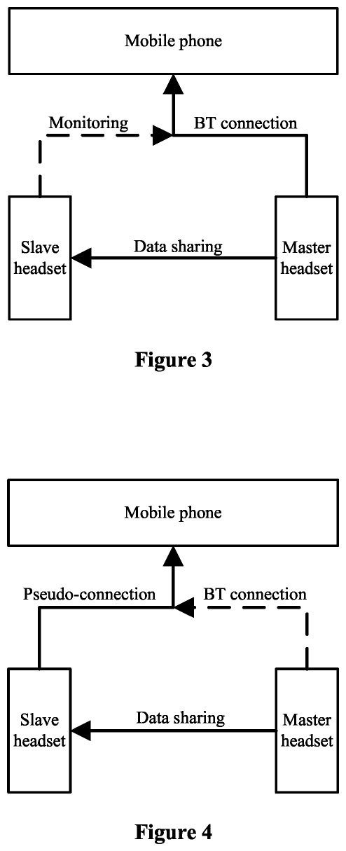

In conjunction with FIG. 3 and FIG. 4, the above process may be illustrated by taking a TWS headset having a master wireless headset (referred to as a master headset) and a slave wireless headset (referred to as a slave headset) as an example.

1. After a Bluetooth connection between the master headset and the slave headset is established, the master headset checks a state (i.e., BT connection state) of the Bluetooth connection between itself and the mobile phone; if there is a Bluetooth connection between the master headset and the mobile phone, the master headset sends first connection parameter information about itself and the mobile phone to the slave headset. Alternatively, after a Bluetooth connection between the master headset and the mobile phone is established, the master headset checks a state of the Bluetooth connection between itself and the slave headset; if there is a Bluetooth connection between the master headset and the slave headset, the master headset sends the first connection parameter information about itself and the mobile phone to the slave headset.

2. During the simultaneous use of the master headset and slave headset in the TWS headset, if a voice call event occurs, the MIC of the master headset operates and the master headset uploads voice data to the mobile phone. During this process, the slave headset monitors the communication process between the master headset and the mobile phone throughout the whole process according to the connection parameter between the master headset and the mobile phone shared by the master headset.

3. If the master headset is taken off at this time, the MIC of the master headset shall be turned off and meanwhile the MIC of the slave headset shall be turned on. The slave headset packages voice data according to the communication parameter (i.e., the first connection parameter information) between the master headset and the mobile phone, and uploads the packaged voice data to the mobile phone. The call goes on seamlessly and there is no Bluetooth disconnection in the whole process.

A computer-readable storage medium is further provided in the present disclosure. The computer-readable storage medium stores a computer program, and the computer program, when executed by a processor, is configured to implement steps of the method for transmitting voice data described in the above embodiments. For example, the computer program, when executed by a processor, is configured to implement steps of: collecting, by a MIC of the second wireless headset, voice data when the second wireless headset receives an instruction to continue transmitting voice data, where the instruction to continue transmitting voice data is an instruction generated after detecting a preset event indicating that the first wireless headset is about to interrupt transmission of the voice data; and transmitting, by the second wireless headset, the voice data collected by the MIC of the second wireless headset to the terminal through the first connection parameter information sent by the first wireless headset.

The computer-readable storage medium may include: a USB flash drive, a portable hard disk, read-only memory (Read-Only Memory, ROM), random access memory (Random Access Memory, RAM), magnetic disk, optical disk, and any other medium that can store program codes.

The connections mentioned in the above embodiments are all wireless connections, such as Bluetooth (BT) connection or Bluetooth low energy (BLE) connection. The connection process is not limited in embodiments of this disclosure, and reference to the conventional technology may be made for details.

The embodiments in the specification are described in a progressive manner. Each embodiment focuses on the differences from other embodiments, and the same or similar parts between various embodiments may be referred to each other. For the apparatus disclosed in the embodiment, since it corresponds to the method disclosed in the embodiment, the description thereof is relatively simple, and the relevant part may be referred to the description of the method part.

Professionals shall further realize that the units and algorithm steps of each example described in combination with the embodiments disclosed herein may be implemented by electronic hardware, computer software, or a combination of both. In order to clearly illustrate the interchangeability of hardware and software, the composition and steps of each example have been generally described in accordance with the function in the above description. Whether these functions are executed by hardware or software depends on the specific application and design constraints of the technical solution. Professionals and technicians may use different methods for each specific application to implement the described functions, but such implementation shall not be considered as beyond the scope of the present disclosure.

The steps of the method or algorithm described in combination with the embodiments disclosed herein may be directly implemented by hardware, a software module executed by a processor, or a combination of the two. The software module may be placed in random access memory (RAM), internal memory, read-only memory (ROM), electrically programmable ROM, electrically erasable programmable ROM, register, hard disk, removable disks, CD-ROM, or any other form of storage medium common known in the technical field.

A method for transmitting voice data, a wireless headset, a TWS headset, and a computer-readable storage medium according to the present disclosure are described above in detail. Specific examples are used herein to illustrate the principle and implementation of the present disclosure. The illustration of the above embodiments is only used to help understand the method and the core ideas of the present disclosure. It should be noted that for those of ordinary skill in the art, several improvements and modifications may be made to the present disclosure without departing from the principle of the present disclosure, and these improvements and modifications shall fall within the protection scope of the claims of the present disclosure.

1. A method for transmitting voice data, wherein a first wireless headset establishes a communication connection with a terminal through first connection parameter information, and a second wireless headset does not establish a communication connection with the terminal, and the method comprises:
collecting, by a microphone (MIC) of the second wireless headset, voice data when the second wireless headset receives an instruction to continue transmitting voice data, wherein the instruction to continue transmitting voice data is an instruction generated after detecting a preset event indicating that the first wireless headset is about to interrupt transmission of voice data; and
transmitting, by the second wireless headset, the voice data collected by the MIC of the second wireless headset to the terminal through the first connection parameter information sent by the first wireless headset.

2. The method for transmitting voice data according to claim 1, wherein before the second wireless headset receives an instruction to continue transmitting voice data, the method further comprises:
receiving the first connection parameter information sent by the first wireless headset.

3. The method for transmitting voice data according to claim 1, wherein the collecting, by a MIC of the second wireless headset, voice data when the second wireless headset receives an instruction to continue transmitting voice data comprises:
turning on the MIC of the second wireless headset and collecting voice data by the MIC of the second wireless headset, when the second wireless headset receives the instruction to continue transmitting voice data.

4. The method for transmitting voice data according to claim 1, wherein the preset event refers that the first wireless headset is taken off.

5. The method for transmitting voice data according to claim 1, wherein the transmitting, by the second wireless headset, the voice data collected by the MIC of the second wireless headset to the terminal through the first connection parameter information sent by the first wireless headset comprises:
packaging, by the second wireless headset, the voice data collected by the MIC of the second wireless headset through the first connection parameter information, and transmitting the packaged voice data to the terminal, wherein the first connection parameter information includes media access control (MAC) address of the terminal, communication time slot, and header information.

6. A wireless headset, comprising a communication interface, a microphone (MIC), a memory and a processor, wherein the memory is configured to store a computer program, and the processor, when executing the computer program, implements steps of the method for transmitting voice data according to claim 1.

7. A true wireless stereo (TWS) headset, comprising a first wireless headset and a second wireless headset each having a microphone (MIC), wherein the first wireless headset establishes a communication connection with a terminal through first connection parameter information, and the second wireless headset does not establish a communication connection with the terminal, wherein,
the second wireless headset collects voice data by means of the MIC of the second wireless headset, when the second wireless headset receives an instruction to continue transmitting voice data; and
the second wireless headset transmits the voice data collected by the MIC of the second wireless headset to the terminal through the first connection parameter information sent by the first wireless headset;
wherein, the instruction to continue transmitting voice data is an instruction generated after detecting a preset event indicating that the first wireless headset is about to interrupt transmission of voice data.

8. The TWS headset according to claim 7, wherein the first wireless headset sends the first connection parameter information to the second wireless headset after the first wireless headset establishes the communication connection with the terminal through the first connection parameter information.

9. The TWS headset according to claim 7, wherein the first wireless headset sends the instruction to continue transmitting voice data to the second wireless headset, in response to detecting the preset event.

10. The TWS headset according to claim 7, wherein the second wireless headset turns on the MIC of the second wireless headset and collects voice data through the MIC of the second wireless headset, upon receiving the instruction to continue transmitting voice data.

11. A computer-readable storage medium, wherein the computer-readable storage medium stores a computer program, and the computer program, when executed by a processor, implements steps of the method for transmitting voice data according to claim 1.

12. A wireless headset, comprising a communication interface, a microphone (MIC), a memory and a processor, wherein the memory is configured to store a computer program, and the processor, when executing the computer program, implements steps of the method for transmitting voice data according to claim 2.

13. A wireless headset, comprising a communication interface, a microphone (MIC), a memory and a processor, wherein the memory is configured to store a computer program, and the processor, when executing the computer program, implements steps of the method for transmitting voice data according to claim 3.

14. A wireless headset, comprising a communication interface, a microphone (MIC), a memory and a processor, wherein the memory is configured to store a computer program, and the processor, when executing the computer program, implements steps of the method for transmitting voice data according to claim 4.

15. A wireless headset, comprising a communication interface, a microphone (MIC), a memory and a processor, wherein the memory is configured to store a computer program, and the processor, when executing the computer program, implements steps of the method for transmitting voice data according to claim 5.

16. The TWS headset according to claim 8, wherein the first wireless headset sends the instruction to continue transmitting voice data to the second wireless headset, in response to detecting the preset event.
